(19) United States
(12) Patent Application Publication
(10) Pub. No.: US 2008/0123973 A1
(43) Pub. Date: May 29, 2008

(54) EXECUTING FUNCTIONS USING IMAGE CODE

(76) Inventors: Seon Hwi CHO, Incheon (KR); Hoon Ju YUN, Seoul (KR)

Correspondence Address: BIRCH STEWART KOLASCH & BIRCH, PO BOX 747, FALLS CHURCH, VA, 22040-0747, US

(21) Appl. No.: 11/877,771

(22) Filed: Oct. 24, 2007

(30) Foreign Application Priority Data
Nov. 27, 2006 (KR) 10-2006-0117561

(51) Int. Cl. G06K 9/36

(52) U.S. Cl. 382/233

(57) ABSTRACT

A method of generating an image code, which includes selecting a function identification code including instructions corresponding to a function to be performed by a terminal and including a content code to represent a target object of the function, and generating the image code including the function identification code and the content code.

This non-provisional application claims priority under 35 U.S.C. § 119(a) to Patent Application No. 10-2006-0117561 filed in the Republic of Korea on Nov. 27, 2006, the entire contents of which are hereby incorporated by reference in its entirety.

### BACKGROUND OF THE INVENTION

1. Field of the Invention

The present document relates to executing functions on a mobile terminal using an image code.

2. Description of the Related Art

Mobile terminals now provide many additional functions besides the basic call function. For example, users can access the Internet, send and receive text and voice messages, watch videos, play games, performing scheduling tasks, etc. using their mobile terminal. As the number of functions has increased, the number of menu options has also increased.

Therefore, the user often has to traverse through several menu options (i.e., a main menu and a plurality of sub-menus) to set or run a particular function. For example, the user can set a particular ring tone on their terminal by selecting a main menu button, selecting a ‘sounds’ sub-menu, selecting a ‘ring tone’ sub-menu, and then selecting one of a plurality of different ring tones.

However, this is often inconvenient to the user, especially to older people who may not be comfortable with using the plurality of different menu options provided on a terminal. In addition, many business people now travel regularly to different countries, which require them to rent a mobile terminal. The user then has to again set a particular ring tone on their rented terminal. Further, each mobile terminal uses a different set of menu options and thus it is not always easy to set a ring tone on a terminal one is not familiar with. The same is true with setting or activating other functions provided on the terminal.

### SUMMARY OF THE INVENTION

Accordingly, one object of the present invention is to address the above-noted and other problems.

Another object of the present invention is to allow a user to easily set or change a particular function on their mobile terminal by capturing an image code including instructions about executing the particular function.

Yet another object of the present invention is to allow a user to generate an image code including instructions about executing a particular function on their terminal.

To achieve these and other advantages and in accordance with the purpose of the present invention, as embodied and broadly described herein, the present invention provides in one aspect a method of generating an image code. The method includes selecting a function identification code to represent a function to be performed by a terminal and a content code to represent a target object of the function, and generating the image code including instructions to execute the selected function with respect to the target object.

In another aspect, the present invention provides a method of executing a function using an image code. The method includes capturing the image code, interpreting the captured image code to obtain a function identification code and a content code, and performing a function corresponding to the function identification code using the content code.

In still another aspect, the present invention provides a mobile communication terminal including a display unit configured to display a function option for selecting one of a plurality of functions that can be performed by the mobile terminal and a content option for selecting a content to represent a target object of the selected function, and an image code generator configured to generate an image code including instructions to execute the selected function with respect to the target object.

In yet another aspect, the present invention provides a mobile communication terminal including a communication terminal configured to communicate with other mobile communication terminals, a camera configured to capturing the image code, an image code recognition unit configured to interpret the captured image code to obtain a function identification code and a content code, and a controller configured to perform a function on the terminal corresponding to the function identification code using the content code.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a block diagram illustrating a mobile terminal according to an embodiment of the present invention;

FIG. 2 is a flowchart illustrating a method of generating an image code according to an embodiment of the present invention;

FIG. 3 is a flowchart illustrating a method of reading and interpreting an image code according to an embodiment of the present invention;

FIG. 4A is an overview illustrating a screen for selecting a function when generating the image code according to an embodiment of the present invention;

FIG. 4B is an overview illustrating a screen for selecting contents when generating the image code according to an embodiment of the present invention; and

FIG. 4C is an overview illustrating a screen for generating an image code according to according to an embodiment of the present invention.

### DETAILED DESCRIPTION OF THE INVENTION

Reference will now be made in detail to the preferred embodiments of the present invention, examples of which are illustrated in the accompanying drawings.

The present invention is directed to generating and reading image codes that correspond to particular functions on a mobile terminal. For example, the user can take a picture of an image code, and the terminal interprets the information contained in the image code to automatically set a particular function on their terminal. The user can also generate an image code corresponding to a particular function on their terminal, and then send the generated image code to another user so the other user can also set the same particular function on their terminal. The user may also print the generated image code on a name card such that the user can repeatedly use the name card to re-execute a particular function on their terminal (or let another user execute the function on their terminal).

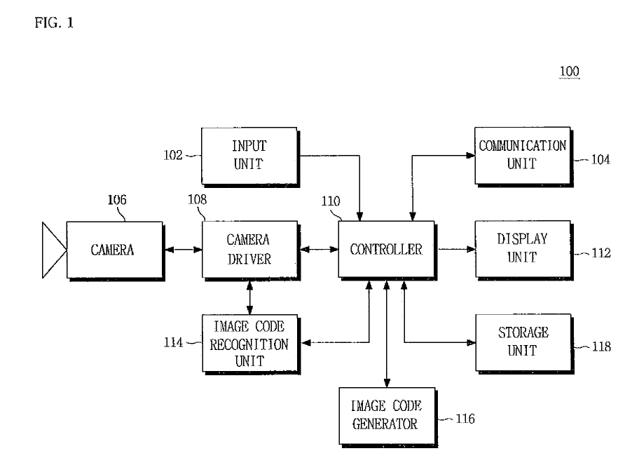

In more detail, an image code is a two-dimensional bar code that carries more information than a one-dimensional bar code. The mobile terminal of the present invention includes the appropriate modules such that the user can capture and generate different image codes corresponding to particular functions on their terminal. For example, FIG. 1 is a block diagram illustrating a mobile terminal 100 according to an embodiment of the present invention.

As shown in FIG. 1, the mobile terminal 100 includes an input unit 102, a communication unit 104, a camera 106, a camera driver 108, a controller 110, a display unit 112, an image code recognition unit 114, an image code generator 116 and a storage unit 118. The input unit 102 receives an instruction input by the user regarding image code generation or an instruction regarding image code recognition. The input unit 102 also includes a variety of buttons used to manipulate the camera 104, and a selection (direction) button for selecting a function and content when an image code is generated.

Further, the communication unit 104 transmits and receives voice signals corresponding to telephone calls sent and received by the user, respectively, and multimedia data and the like to and from other mobile terminals via a mobile communication network. That is, the communication unit 104 includes a transceiver unit for transmitting and receiving voice signals and data.

In addition, the camera 106 is used by the user to photograph an image code that includes information for setting a particular function on the terminal. The user can also use the camera 106 to take other pictures. In addition, the camera driver 108 drives the camera 106, and converts the image signal received from the camera 106 into image data.

Also, when the user inputs an image code generating instruction using the input unit 102, the controller 110 displays on the display unit a plurality of options related to image code generation that the user can select. The controller 110 then controls the image code generator 116 to generate the desired image code and stores the generated image code in the storage unit 118. Similarly, if the user inputs an image code recognition instruction using the input unit 102, the controller 110 drives the camera driver 108, which in turn controls the camera 106 to photograph the image code. The controller 110 then controls the image code recognition unit 114 to interpret the photographed image code, and execute a function included in the image code.

Further, the display unit 112 displays an operating status of the mobile terminal 100, and also the different menu options that can be selected by the user to control the mobile terminal 100. The display unit 112 also displays the different image codes. Also, the image code recognition unit 114 reads and interprets the photographed image code, and also transmits the information of the interpreted image code to the controller 110.

In addition, as mentioned above, the image code generator 116 generates an image code corresponding to the execution of a function selected by a user. For example, the function may be to store a file in the storage unit 118, to execute a file on the Internet via a Wireless Application Protocol (WAP), to set a particular ring tone, etc. Further, the image code includes a function identification code that instructs the terminal to perform a particular function, and a content code that includes the target object to be executed on the terminal 100 (e.g., a background picture, a ring tone, etc.).

That is, the function instructed by the image code may be to automatically change the background screen of the terminal 100 to an image included in the image code, or to automatically change the ring tone of the terminal 100 to a ring tone included in the image code. Thus, the image code includes the instructions (function identification code) and corresponding ring tone or background image (content code) that is to be executed on the terminal 100.

Further, the content code inscribed on the image code may include a plurality of frequently used phrases and the telephone numbers of friends, business associates or partners, etc. The function identification code may also instruct the terminal 100 to transmit an SMS message to any one of the telephone numbers in which the SMS message includes any one of the frequently used phrases included in the content code.

The content code may also include a specific Uniform Resource Locator (URL) address, and the function identification code may include instructions instructing the terminal 100 to connect to the Internet using the specific URL address included in the content code. Further, the content code may include a file stored in the terminal 100, or a URL address on the Internet where the file exists. In this instance, the function identification code includes instructions instructing the terminal 100 to display the file (e.g., a multimedia file or other file) that is stored on the terminal 100 or that is identified by the URL address. In addition, the storage unit 118 stores the image code generated by the image code generator 116, as well as a plurality of function execution programs and corresponding contents associated with the execution programs.

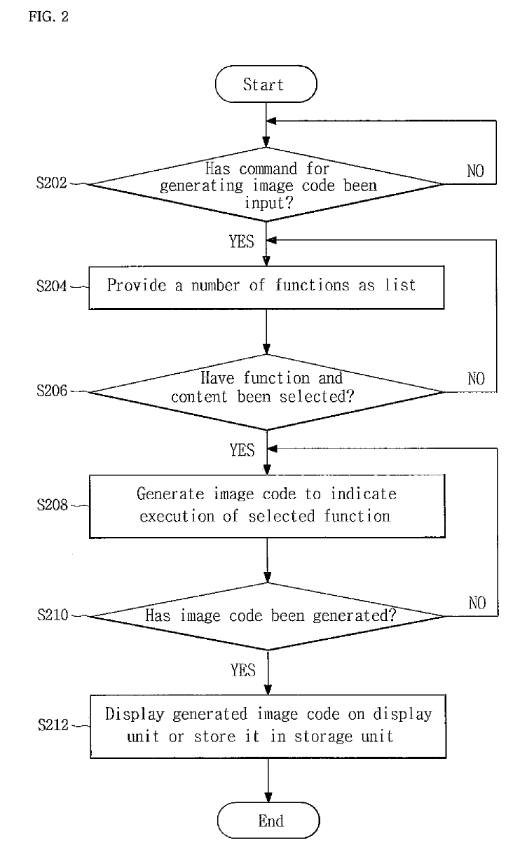

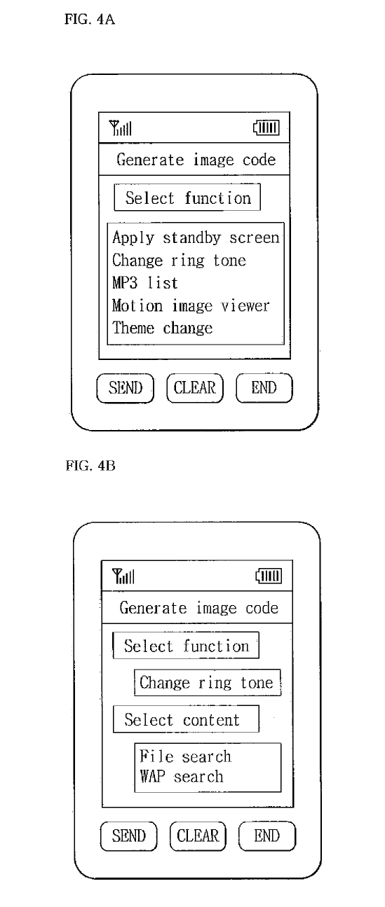

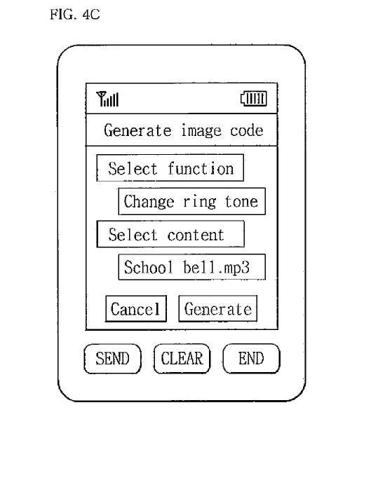

Next, FIG. 2 is a flowchart illustrating a method of generating an image code according to an embodiment of the present invention. FIG. 1 will also be referred to in this description. As shown in FIG. 2, the controller 110 determines if the user has input image generation code instruction using the input unit 102 (S202). Further, when the user inputs such a command (Yes in S202), the controller 110 displays a plurality of functions on the display unit 112 as shown in FIG. 4A, for example (S204).

That is, FIG. 4A is an overview illustrating a screen for selecting a function when the user wants to generate an image code. Then, when the user selects, for example, the “Change ring tone” function from the plurality of functions, the controller 110 displays a screen on the display unit 112 that allows the user to select a particular ring tone (target content) for the “Change ring tone” function as illustrated in FIG. 4B. That is. FIG. 4B is an overview illustrating a screen for selecting content when the user wants to generate an image code.

As shown in FIG. 4B, the user can search for a particular ring tone on the terminal itself (File search) or via the Internet, for example (WAP search). In the example shown in FIG. 4B, it is assumed the user selects the File Search option and then selects a “School bell.mp3” ring tone file from the storage unit 118. FIG. 4C illustrates this example in more detail. Then, the user can select the “Generate” menu option in FIG. 4C to generate the image code, which includes instructions instructing the terminal to change the ring tone to the “School bell.mp3” ring tone.

In more detail, when the user selects the “Generate” menu option, the controller 110 controls the image code generator 116 to generate the image code (S208). The controller 110 then determines if the image code has been successfully generated (S210). When the image code has been successfully generated (Yes in S210), the controller 110 displays the generated image code on the display unit 112 or stores the generated image code in the storage unit 118 (S212). The controller 110 also notifies the user the image code has been successfully generated.

In addition, as shown in FIG. 4B, the method of generating an image code is classified into to selecting the function and selecting the content associated with the function. As shown in FIG. 4A, the functions includes a plurality of different functions such as “Apply standby screen”, “Change ring tone”, “MP3 List”, “Motion image viewer”, and “Theme change”. In addition, as discussed above, the user can select a corresponding content using a file search option or using a WAP search option. However, the user may also search for a particular content using a search option such as GOOGLE, and then input a name of a desired content. The user can then select a desired content from the list of searched results. The “Motion image viewer” function executes a Multimedia player on the terminal.

In addition, the format of the image code may be a barcode, a OR code, Data Matrix, PDF 417, Maxi Code, Color Code, Gray Code, 3-D barcode, and so on. Also, the format of the image code may be a raster-based bitmap file, a vector-based metafile and the like. In addition, the user can transfer the generated image code to another terminal using a multimedia message service on the terminal, using a USB or UART port on the terminal or by having the generated image code printed such that another user can capture the printed image. The image code may also be printed on a name card such that the user can repeatedly use or show the generated image code.

Further, the plurality of available functions are not limited to the functions shown in FIG. 4A. For example, the available functions also include “Dialing”, “Send SMS message”, etc. In more detail, if the user selects the “Dialing” function, a number of telephone numbers and an automatic dialing function can be generated in the image code. Also, if the user selects the “Send SMS message” function, a number of recipient numbers, a commercial phrase and an automatic text transmission function can be generated in the image code.

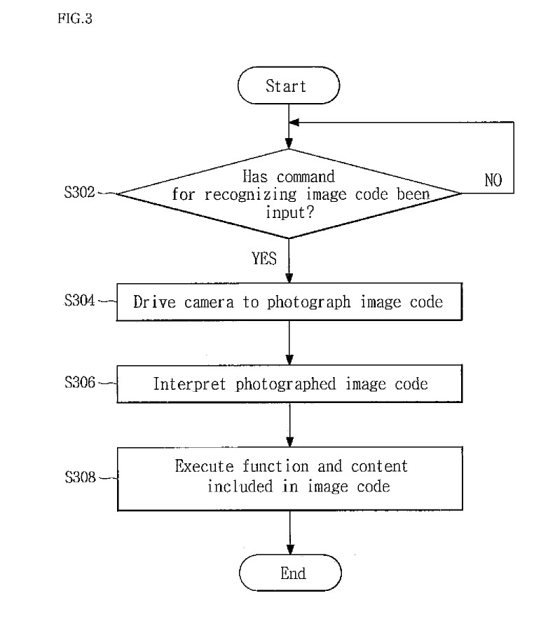

Next, FIG. 3 is a flowchart illustrating a method of recognizing or reading an image code according to an embodiment of the present invention. FIG. 1 will also be referred to in this description. Referring to FIG. 3, the controller 110 determines if the user has input an image code recognition command using the input unit 102 of the mobile terminal 100 (S302).

When the user has input such a command (Yes in S302), the controller 110 controls the camera driver 108 to drive the camera 106 and photograph an image code (S304). As discussed above, the image code may be an image code printed on a user's name card, or an image code displayed on a terminal. The image code also includes a function identification code and a content code. Further, the camera driver 108 converts the photographed image code into image data.

Then, the controller 110 controls the image code recognition unit 114 to interpret the captured image code (S306). That is, the image code recognition unit 114 interprets the function identification code and the content code included the image code. Further, the controller 110 uses the interpreted function identification code and the content code to execute the corresponding function (e.g., change the ring tone) using the content (School bell ring tone) (S308).

As discussed above, the function included in the image code may be “Change ring tone”, “Apply standby screen”, “MP3 List”, “Motion image viewer”, “Theme change”, “Dialing”, “Send SMS message” and so on. The image code may also include a URL address of a website as the content code, and instructions to access the URL address as the function identification code.

Furthermore, the function identification code included in the image code can be matched to, for example, an execution file of a function program on the terminal, and include numbers, texts or a combination of thereof to identify the function program, an execution file name, an execution file extension, and so on. The function program may also be used to execute a Word Processor, Spreadsheet Program, Presentation Program, an e-mail program, a database program and the like.

The function identification code may also include a source code in HTML format, for executing web pages in a web browser, and text in TXT format to show text contents. In addition, the function identification code may include code for executing a specific menu of a web page, controlling an environment setting such as the style of Word Processor and page setting, and executing a function icon.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method of generating an image code, the method comprising:
selecting a function identification code including instructions corresponding to a function to be performed by a terminal and including a content code to represent a target object of the function; and
generating the image code including the function identification code and the content code.

2. The method of claim 1, wherein selecting the function identification code and the content code comprises:
searching a list of function identification codes and a list of content codes; and
selecting the function identification code and the content code from each of the lists.

3. The method of claim 1, wherein the content code represents one of a file stored in the terminal and a Uniform Resource Locator (URL) pointing to a file on the Internet.

4. The method of claim 1, further comprising:
storing the generated image code.

5. The method of claim 1, wherein the function identification code includes one of instructions to execute a file stored in the terminal and that is indicated in the content code, and instructions to execute a file linked to the Internet through a Wireless Application Protocol (WAP) and that is indicated in the content code.

6. The method of claim 1, wherein the function identification code includes one of instructions to automatically change a background screen of the terminal to an image included in the content code, and instructions to automatically change a ring tone of the terminal to a ring tone included in the content code.

7. The method of claim 1, wherein the content code comprises a phrase and a recipient number, and the function identification code includes instructions instructing the terminal to transmit an SMS (Short Message Service) message to the recipient number using the phrase included in the content code.

8. The method of claim 1, wherein the content code comprises a URL (Uniform Resource Locator) address and the function identification code includes instructions instructing the terminal to connect to the URL address on the Internet.

9. A method of executing a function using an image code, the method comprising:
capturing the image code;
interpreting the captured image code to obtain a function identification code and a content code; and
performing a function corresponding to the function identification code using the content code.

10. The method of claim 9, wherein capturing the image code captures the image code using a camera or a recognition unit.

11. The method of claim 9, wherein the function identification code comprises an application code or a theme change code.

12. The method of claim 11, wherein the application code includes instructions to execute a multimedia player, and the theme change code includes instructions to change a background screen or a standby screen.

13. The method of claim 9, wherein the content code comprises at least one of coded contents, a content file stored in a terminal, and a Uniform Resource Locator (URL) address pointing to a file on the Internet.

14. The method of claim 9, wherein the function identification code includes one of instructions to execute a file stored in the terminal and that is indicated in the content code, instructions to execute a file linked to the Internet through a Wireless Application Protocol (WAP) and that is indicated in the content, instructions to automatically change a background screen of the terminal to an image included in the content code, and instructions to automatically change a ring tone of the terminal to a ring tone included in the content code.

15. The method of claim 9, wherein the content code comprises a phrase and a recipient number, and the function identification code includes instructions instructing the terminal to transmit an SMS (Short Message Service) message to the recipient number using the phrase included in the content code.

16. A mobile communication terminal, comprising:
a display unit configured to display a function option for selecting one of a plurality of functions that can be performed by the mobile terminal and a content option for selecting a content to represent a target object of the selected function; and
an image code generator configured to generate an image code including the function identification code and the content code.

17. The mobile communication terminal of claim 16, wherein the generated image code includes a function identification code including instructions to execute the selected function and a contents code including the target object.

18. The mobile communication terminal of claim 17, wherein the content code represents one of a file stored in the terminal and a Uniform Resource Locator (URL) pointing to a file on the Internet.

19. The mobile communication terminal of claim 17, wherein the function identification code includes one of instructions to execute a file stored in the terminal and that is indicated in the content code, instructions to execute a file linked to the Internet through a Wireless Application Protocol (WAP) and that is indicated in the content code, instructions to automatically change a background screen of the terminal to an image included in the content code, and instructions to automatically change a ring tone of the terminal to a ring tone included in the content code.

20. The mobile communication terminal of claim 17, wherein the content code comprises a phrase and a recipient number, and the function identification code includes instructions instructing the terminal to transmit an SMS (Short Message Service) message to the recipient number using the phrase included in the content code.

21. The mobile communication terminal of claim 17, wherein the content code comprises a URL (Uniform Resource Locator) address and the function identification code includes instructions instructing the terminal to connect to the URL address on the Internet.

22. A mobile communication terminal, comprising:
a communication terminal configured to communicate with other mobile communication terminals;
a camera configured to capturing an image code;
an image code recognition unit configured to interpret the captured image code to obtain a function identification code and a content code from the captured image code; and
a controller configured to perform a function on the terminal corresponding to the function identification code using the content code.

23. The mobile communication terminal of claim 22, wherein the function identification code includes one of instructions to execute a multimedia player on the terminal, instructions to change a background screen or a standby screen of the terminal, instructions to execute a file stored in the terminal and that is indicated in the content code, instructions to execute a file linked to the Internet through a Wireless Application Protocol (WAP) and that is indicated in the content code, instructions to automatically change a background screen of the terminal to an image included in the content code, and instructions to automatically change a ring tone of the terminal to a ring tone included in the content code.

24. The mobile communication terminal of claim 22, wherein the content code comprises at least one of coded contents, a content file stored in a terminal, and a Uniform Resource Locator (URL) address pointing to a file on the Internet.

25. The mobile communication terminal of claim 22, wherein the content code comprises a phrase and a recipient number, and the function identification code includes instructions instructing the terminal to transmit an SMS (Short Message Service) message to the recipient number using the phrase included in the content code.
